(19) United States
(12) Patent Application Publication
(10) Pub. No.: US 2006/0135394 A1
(43) Pub. Date: Jun. 22, 2006

(54) Car wash composition for hard water, and methods for manufacturing and using

(76) Inventors: Kim R. Smith, Woodbury, MN (US); Keith E. Olson, Apple Valley, MN (US)

Correspondence Address: ECOLAB INC., MAIL STOP ESC-F7, 655 LONE OAK DRIVE, EAGAN, MN, 55121, US

(21) Appl. No.: 11/018,046

(22) Filed: Dec. 20, 2004

(51) Int. Cl. C11D 17/00

(52) U.S. Cl. 510/424

(57) ABSTRACT

A composition is provided; the composition is particularly suitable as a car wash detergent composition. The car composition includes an anionic surfactant and a hard water anti-precipitant mixture. The hard water anti-precipitant mixture includes a dispersant polymer and at least one of a sheeting agent and a humectant. Methods for providing and using a ready-to-use composition are provided. The composition is particularly suited for dilution with hard water and at cold temperatures.

### FIELD OF THE INVENTION

The invention relates to a composition and to methods for manufacturing and using a composition. In particular, the composition resists precipitation of anionic surfactant as a result of dilution with hard water. The composition is particularly suitable as a car wash composition, and can be provided as a concentrate and diluted with dilution water to provide a detergent use solution.

### BACKGROUND OF THE INVENTION

An automobile, or other vehicle, represents a considerable expense, both the purchase or lease of the vehicle and its maintenance. However, despite rising sticker prices, luxury and sports automobiles continue to be sought after. The prestige of driving an attractive car endures monetary inhibitions.

Because of the large monetary expenditure created by vehicles, many owners or uses rely on routine cleaning and maintenance to maximize their enjoyment, as well as the life and beauty of their car. Cleaning and detailing a vehicle instantly improves its appearance. A shining exterior conveys a sense of luxury and pride for all to see. Whether luxury or economy, a car with a freshly cleaned body and spotless windows is to be admired.

Unfortunately, washing a vehicle such as a car, truck, SUV or van, is a time-consuming and labor-intensive endeavor. Additionally, having a vehicle washed by a professional, is a money-intensive endeavor. Because many owners cannot afford a professional washing regularly, many owners wash the vehicle themselves. Other owners enjoy the act of washing the vehicle themselves.

Hand washing a vehicle typically involves wetting the vehicle surface with a hose, such the garden hose, applying a washing detergent to the vehicle surface, and then rinsing the surface with the hose. Those more dedicated owners usually towel dry the vehicle surface. For most consumers, especially the ‘backyard variety’, the washing detergent is obtained by placing an amount of concentrated detergent in a bucket and adding water to the bucket from the garden hose or other residential source, such as a kitchen sink.

For many households, the water in the garden hose, and possibly the kitchen sink, is hard water, having a hardness of at least 1 grain and often of at least 5 grain. This hard water wrecks havoc on many commercially available car wash detergents, causing a precipitate to form in the bucket. Most consumers do not realize that the cloudy solution in their wash bucket is an undesired by-product caused by the reaction of the water with the detergent. Cold water is particularly hostile at forming the precipitate.

The present invention provides a car wash detergent that inhibits the formation of precipitate in the wash bucket, especially at cold temperatures.

### SUMMARY OF THE INVENTION

A composition is provided according to the invention. The composition includes an anionic surfactant component and a hard water anti-precipitant mixture, which includes a dispersant polymer and at least one of a sheeting agent and a humectant. The hard water anti-precipitant mixture can include a mixture of the sheeting agent and the humectant. The sheeting agent is, in general, a nonionic surfactant.

The ratio of the dispersant polymer to the total amount of the sheeting agent and the humectant should be sufficient to prevent visible precipitation of the anionic surfactant when in the presence of common hard water ions such as calcium, iron, sodium, and the like, at ambient temperature, and preferably below ambient temperature. The weight ratio of the dispersant polymer to the total amount of the sheeting agent and the humectant can be at least about 1:75 and can be less than about 75:1. It should be understood that the total amount of the sheeting agent and the humectant refers to the total amount of the sheeting agent, if present at all, and the total amount of the humectant, if present at all.

The composition does not form a visible precipitate in the presence of hard water ions when at ambient temperature. Preferably, the composition does not form a visible precipitate in the presence of hard water ions at a temperature of about 60° F., more preferably not at a temperature of above 40° F. The composition is particularly adapted to not forming a precipitate when diluted with cold hose water.

The composition can be provided in the form of a concentrate or in the form of a ready-to-use composition or in the form of a use solution. In general, it is expected that the concentrate will be diluted to the use composition. In the case of a car wash detergent, it is expected that the ready-to-use composition and the use solution will be the same because the ready-to-use composition is typically applied directly to a surface.

A method for providing a use composition is provided according to the invention. The method includes a step of diluting a composition concentrate with dilution water to provide a ready-to-use composition. The dilution water can include water hardness at a level of at least about 1 grain, although in many applications the water hardness is at a level of at least about 5 grain. The composition concentrate can also be diluted with water having a hardness of at least about 15 grain, without the formation of precipitate. The dilution water can be 60° F. or less, and also 40° F. or less.

A method for using a composition is provided according to the invention. The method includes a step of diluting a concentrate with dilution water to provide a use composition, and applying the use composition to a hard surface, particularly an automotive or other vehicle surface. Often, the surface is a painted surface that includes a clearcoat. The method can include a step of foaming the use composition so that a foam of the use composition is applied to the surface for cleaning. The step of foaming can be provided by mechanical foaming without a propellant.

### DETAILED DESCRIPTION OF THE INVENTION

The composition can be referred to as a detergent composition and can be provided in the form of a concentrated detergent composition, a ready-to-use detergent composition, and/or a detergent use solution or use composition. The concentrated detergent composition can be referred to as the concentrate, and can be diluted to provide the ready-to-use detergent composition. The concentrate can be diluted in stages to eventually provide a ready-to-use detergent composition. The ready-to-use detergent composition can be referred to as the use solution when it is the solution that is intended to be used to provide cleaning of a surface. In addition, the ready-to-use detergent composition can be further diluted to provide the use solution. In the case of a car wash detergent, it is expected that the diluted composition will be the use solution and applied directly to an automobile or other vehicle surface.

The composition can be provided as a concentrate for shipment to retail distributors or commercial or residential end users. It is expected that the end user, either the commercial or residential user, will dilute the concentrate, such as in a tank or a bucket, to provide a car wash use composition. It is expected that commercial end users, such as car washing facilities, will dilute the concentrate in large volumes in tanks, such as 1000 gallons, to achieve a ready-to-use composition and then use the ready-to-use composition as part of their cleaning service. The ready-to-use composition may be further diluted to form the use composition. It is expected that residential end users, such as individual persons, will dilute the concentrate in a bucket from a garden hose or tap to achieve a use composition.

By providing the composition as a concentrate, it is expected that the concentrate will be diluted with the water available at the locale or site of dilution. It is recognized that the level of water hardness changes from one locale to another. Accordingly, it is expected that that concentrate will be diluted with water having varying amounts of hardness depending upon the locale or site of dilution.

In general, water hardness refers to the presence of calcium, magnesium, iron, manganese, and other polyvalent metal cations that may be present in the water, and it is understood that the level of water hardness varies from municipality to municipality. The concentrated detergent composition is formulated to handle differing water hardness levels found in varying locations without having to soften the water or remove the hardness from the water. High solids containing water is considered to be water having a total dissolved solids (TDS) content in excess of 200 ppm. In certain localities, the service water contains a total dissolved solids content in excess of 400 ppm, and even in excess of 800 ppm. Water hardness can be characterized by the unit “grain” where one grain water hardness is equivalent to 17.1 ppm hardness expressed as CaCO₃. Hard water is characterized as having at least 1 grain hardness. Water is commonly available having at least 5 grains hardness, at least 10 grains hardness, and at least 15 grains hardness. Water as hard as 20 grains is not uncommon.

The hardness in water can cause anionic surfactants to precipitate. Visual precipitation refers to precipitate formation that can be observed by the naked eye without visual magnification or enhancement. In order to protect the anionic surfactant component in the composition of the invention, a hard water anti-precipitant mixture is provided that includes a dispersant polymer and at least one of a sheeting agent and a humectant. The composition can include additional surfactants and other components commonly found in cleaning compositions.

### Anionic Surfactant Component

The anionic surfactant component includes a detersive amount of an anionic surfactant or a mixture of anionic surfactants. Anionic surfactants are desirable in cleaning compositions because of their wetting and detersive properties. The anionic surfactants that can be used according to the invention include any anionic surfactant available in the cleaning industry. Exemplary groups of anionic surfactants include sulfonates and sulfates. Exemplary surfactants that can be provided in the anionic surfactant component include alkyl aryl sulfonates, secondary alkane sulfonates, alkyl methyl ester sulfonates, alpha olefin sulfonates, alkyl ether sulfates, alkyl sulfates, and alcohol sulfates.

Exemplary alkyl aryl sulfonates that can be used in the composition can have an alkyl group that contains 1 to 24 carbon atoms and the aryl group can be at least one of benzene, toluene, and xylene. An exemplary alkyl aryl sulfonate includes linear alkyl benzene sulfonate. An exemplary linear alkyl benzene sulfonate includes linear dodecyl benzyl sulfonate that can be provided as an acid that is neutralized to form the sulfonate. Additional exemplary alkyl aryl sulfonates include xylene sulfonate and cumene sulfonate.

Exemplary alkane sulfonates that can be used in the composition can have an alkane group having 6 to 24 carbon atoms. Exemplary alkane sulfonates that can be used include secondary alkane sulfonates. An exemplary secondary alkane sulfonate includes sodium C₁₄-C₁₇ secondary alkyl sulfonate commercially available as Hostapur SAS from Clariant.

Exemplary alkyl methyl ester sulfonates that can be used in the composition include those having an alkyl group containing 6 to 24 carbon atoms.

Exemplary alpha olefin sulfonates that can be used in the composition include those having alpha olefin groups containing 6 to 24 carbon atoms.

Exemplary alkyl ether sulfates that can be used in the composition include those having 1 to 10 repeating alkoxy groups, or 1 to 5 repeating alkoxy groups. In general, the alkoxy group will contain 2 to 4 carbon atoms. An exemplary alkoxy group is ethoxy. An exemplary alkyl ether sulfate is sodium lauric ether ethoxylate sulfate and is available under the name Steol CS-460.

Exemplary alkyl sulfates that can be used in the composition include those having an alkyl group containing 6 to 24 carbon atoms. Exemplary alkyl sulfates include sodium laurel sulfate and sodium laurel/myristyl sulfate.

The anionic surfactant can be neutralized with an alkaline metal salt, an amine, or a mixture thereof. Exemplary alkaline metal salts include sodium, potassium, and magnesium. Exemplary amines include monoethanolamine, triethanolamine, and monoisopropanolamine. If a mixture of salts is used, an exemplary mixture of alkaline metal salt can be sodium and magnesium, and the molar ratio of sodium to magnesium can be between about 3:1 and about 1:1.

The composition, when provided as a concentrate, can include the anionic surfactant component in an amount sufficient to provide a use solution having desired wetting and detersive properties after dilution with water. The concentrate can be provided as a solid, paste or as a liquid. The solid concentrate can be in the form of a molded product of a fixed shape (e.g., tablet), powder, agglomerate, or pellets. The solid concentrate can be dispensed in a variety of dispensers known to the art, added directly to water for dilution, or contained in a water-soluble packaging which can be added to water for dilution. When the concentrate is provided as a liquid, it can be provided in a form that is readily flowable so that it can be poured, pumped or aspirated or added as a unit dose in water-soluble packaging. It is additionally desirable to minimize the amount of water while preserving the flowable properties of the concentrate when it is provided as a fluid.

The concentrate can contain about 0.1 wt. % to about 50 wt. % of the anionic surfactant component, about 1 wt. % to about 30 wt. % of the anionic surfactant component, or about 5 wt. % to about 20 wt. % of the anionic surfactant component.

### Hard Water Anti-Precipitant Mixture

The hard water anti-precipitant includes a mixture of a dispersant polymer and at least one of a sheeting agent and a humectant. The combination of the dispersant polymer and the at least one of a sheeting agent and a humectant provides the use solution with resistance to precipitation of the anionic surfactant component caused by hardness in the water. In addition, it is believed that the combination of the dispersant polymer and the sheeting agent and/or the humectant can provide stability from precipitation at temperatures down to 60° F. (about 15° C.), down to 40° F. (about 4° C.), and even at temperatures down to about freezing. It is preferred that the combination is stable at the temperature of water or other solvent used to dilute the composition. The dispersant polymer and the sheeting agent and/or the humectant are believed to act synergistically to provide protection against precipitation of anionic surfactants in the presence of hard water.

The dispersant polymer is a component that is conventionally added to cleaning compositions to handle the hardness found in water. Dispersant polymers that can be used according to the invention include those that are referred to as “lime soap dispersant polymers.” In general, it is understood that dispersant polymers have a tendency to interfere with precipitation of anionic surfactants caused by water hardness.

Dispersant polymers that can be used according to the invention can include a polymer and/or an oligomer containing pendant carboxylic acid groups and/or pendant carboxylic acid salt groups. It should be understood that the term “pendant” refers to the groups being present other than in the polymer backbone and/or oligomer backbone. The dispersant polymers can be available as homopolymers or co-polymers or as homoligomers or co-oligomers. Exemplary dispersant polymers include poly(acrylic acid), poly (acrylic acid/maleic acid) co-polymers, poly(maleic acid/olefin) co-polymers, phosphino carboxylated polymers, and mixtures thereof. The dispersant polymers can be soluble or dispersable in the concentrate and can be a component that does not significantly increase the viscosity of the concentrate or of the use solution relative to its absence.

The dispersant polymer can be a homopolymer or co-polymer, and can have a molecular weight range of about 300 to about 5,000,000, and can have a molecular weight range of about 2,000 to about 2,000,000, and can have a molecular weight range of about 3,000, to about 500,000. The dispersant polymer can include repeating units based upon acrylic acid, maleic acid, polyols, olefins, and mixtures thereof. An exemplary dispersant polymer is a maleic anhydride/olefin co-polymer. An exemplary maleic anhydride/olefin co-polymer is available from Rohm & Haas under the name of Acusol 460N. An exemplary polyacrylic acid sodium salt having a molecular weight of about 4,500 is available from Rohm & Haas under the name Acusol 434N. An exemplary acrylic acid/maleic acid co-polymer having a molecular weight of about 3,200 is available from Rohm & Haas under the Acusol 448. An exemplary acrylic acid/maleic acid sodium salt having a molecular weight of about 70,000 is available from Rohm & Haas under the name Acusol 479N. An exemplary acrylic acid/maleic acid sodium salt having a molecular weight of about 40,000 is available from Rohm & Haas under the name Acusol 505N.

In general, if the dispersant polymer is provided as an acid, its pH may be adjusted to neutral or alkaline. The pH adjustment may be provided prior to forming the concentrate or during the formation of the concentrate. In addition, the pH adjustment may occur at any time prior to or during dilution with the dilution water to provide the use solution.

The dispersant polymer can be provided in the concentrate in an amount sufficient, when taken in consideration of the amount of sheeting agent and/or humectant, to provide resistance to precipitation of the anionic surfactant component when diluted with hard water.

In general, the concentrate can contain about 0.01 wt. % to about 10 wt. % dispersant polymer, about 0.2 wt. % to about 5 wt. % dispersant polymer, or about 0.5 wt. % to about 1.5 wt. % dispersant polymer.

The sheeting agent and/or humectant can be any component that provides a desired level of sheeting action and, when combined with the dispersant polymer, creates a resistance to precipitation of the anionic surfactant component in the presence of hard water.

Exemplary sheeting agents that can be used according to the invention include surfactant including nonionic block copolymers, alcohol alkoxylates, alkyl polyglycosides, zwitterionics, anionics, and mixtures thereof. Additional exemplary sheeting agents include alcohol ethoxylates; alcohol propoxylates; alkylphenol ethoxylate-propoxylates; alkoxylated derivatives of carboxylic acids, amines, amids and esters; and ethylene oxide-propylene oxide copolymers. Exemplary ethylene oxide-propylene oxide polymers include those available under the name Pluronic, Pluronic R, Tetronic, and Tetronic R from BASF.

Exemplary nonionic block copolymer surfactants include polyoxyethylene-polyoxypropylene block copolymers. Exemplary polyoxyethylene-polyoxypropylene block copolymers that can be used have the formulae:
(EO)ₓ(PO)_{y}(EO)ₓ
(PO)_{y}(EO)ₓ(PO)_{y}
(PO)_{y}(EO)ₓ(PO)_{y}(EO)ₓ(PO)_{y}
wherein EO represents an ethylene oxide group, PO represents a propylene oxide group, and x and y reflect the average molecular proportion of each alkylene oxide monomer in the overall block copolymer composition. Preferably, x is from about 10 to about 130, y is about 15 to about 70, and x plus y is about 25 to about 200. It should be understood that each x and y in a molecule can be different. The total polyoxyethylene component of the block copolymer is preferably at least about 20 mol-% of the block copolymer and more preferably at least about 30 mol-% of the block copolymer. The material preferably has a molecular weight greater than about 1,500 and more preferably greater than about 2,000. Although the exemplary polyoxyethylene-polyoxypropylene block copolymer structures provided above have 3 blocks and 5 blocks, it should be appreciated that the nonionic block copolymer surfactants according to the invention can include more or less than 3 and 5 blocks. In addition, the nonionic block copolymer surfactants can include additional repeating units such as butylene oxide repeating units. Furthermore, the nonionic block copolymer surfactants that can be used according to the invention can be characterized heteric polyoxyethylene-polyoxypropylene block copolymers. Exemplary sheeting agents that can be used according to the invention are available from BASF under the name Pluronic, and an exemplary EO-PO co-polymer that can be used according to the invention is available under the name Pluronic N3.

A desirable characteristic of the nonionic block copolymers is the cloud point of the material. The cloud point of nonionic surfactant of this class is defined as the temperature at which a 1 wt-% aqueous solution of the surfactant turns cloudy when it is heated. BASF, a major producer of nonionic block copolymers in the United States recommends that rinse agents be formulated from nonionic EO-PO sheeting agents having both a low molecular weight (less than about 5,000) and having a cloud point of a 1 wt-% aqueous solution less than the typical temperature of the aqueous rinse. It is believed that one skilled in the art would understand that a nonionic surfactant with a high cloud point or high molecular weight would either produce unacceptable foaming levels or fail to provide adequate sheeting capacity in a rinse aid composition.

The alcohol alkoxylate surfactants that can be used as sheeting agents according to the invention can have the formula:
R(AO)Xₓ—X
wherein R is an alkyl group containing 6 to 24 carbon atoms, AO is an alkylene oxide group containing 2 to 12 carbon atoms, x is 1 to 20, and X is hydrogen or an alkyl or aryl group containing 1-12 carbon atoms. The alkylene oxide group is preferably ethylene oxide, propylene oxide, butylene oxide, or mixture thereof. In addition, the alkylene oxide group can include a decylene oxide group as a cap.

The alkyl polyglycoside surfactants that can be used as sheeting agents according to the invention can have the formula:
(G)ₓ—O—R
wherein G is a moiety derived from reducing saccharide containing 5 or 6 carbon atoms, e.g., pentose or hexose, R is a fatty aliphatic group containing 6 to 24 carbon atoms, and x is the degree of polymerization (DP) of the polyglycoside representing the number of monosaccharide repeating units in the polyglycoside. The value of x can be about 0.5 to about 10. R can contain 10-16 carbon atoms and x can be 0.5 to 3.

The zwitterionic surfactants that can be used as sheeting agents according to the invention include β-N-alkylaminopropionates, N-alkyl-β-iminodipropionates, imidazoline carboxylates, N-alkylbetaines, sulfobetaines, sultaines, amine oxides and polybetaine polysiloxanes. Preferred polybetaine polysiloxanes have the formula: 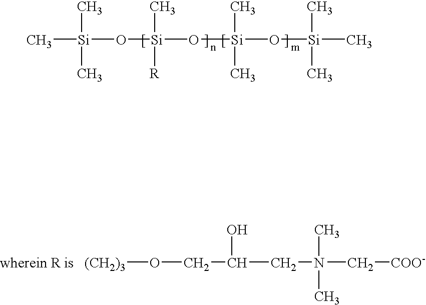
n is 1 to 100 and m is 0 to 100, preferably 1 to 100. Preferred polybetaine polysiloxanes are available under the name ABIL® from Goldschmidt Chemical Corp. Preferred amine oxides that can be used include alkyl dimethyl amine oxides containing alkyl groups containing 6 to 24 carbon atoms. A preferred amine oxide is lauryl dimethylamine oxide.

The anionic surfactants that can be used as sheeting agents according to the invention include carboxylic acid salts, sulfonic acid salts, sulfuric acid ester salts, phosphoric and polyphosphoric acid esters, perfluorinated anionics, and mixtures thereof. Exemplary carboxylic acid salts include sodium and potassium salts of straight chain fatty acids, sodium and potassium salts of coconut oil fatty acids, sodium and potassium salts of tall oil acids, amine salts, sarcosides, and acylated polypeptides. Exemplary sulfonic acid salts include linear alkylbenzenesulfonates, C₁₃-C₁₅ alkylbenzenesulfonates, benzene cumenesulfonates, toluene cumenesulfonates, xylene cumenesulfonates, ligninsulfonates, petroleum sulfonates, N-acyl-n-alkyltaurates, paraffin sulfonates, secondary n-alkanesulfonates, alpha-olefin sulfonates, sulfosuccinate esters, alkylnaphthalenesulfonates, and isethionates. Exemplary sulphuric acid ester salts include sulfated linear primary alcohols, sulfated polyoxyethylenated straight-chain alcohols, and sulfated triglyceride oils.

Exemplary surfactants which can be used as sheeting agents according to the invention are disclosed in Rosen, Surfactants and Interfacial Phenomena, second edition, John Wiley & sons, 1989, the entire document being incorporated herein by reference. Humectants that can be used according to the invention include those substances that exhibit an affinity for water and help enhance the absorption of water onto a substrate. If the humectant is used in the absence of a sheeting agent, the humectant should be capable of cooperating with the dispersant polymer to resist precipitation of the anionic surfactant in the presence of hard water. Exemplary humectants that can be used according to the invention include glycerine, propylene glycol, sorbitol, alkyl polyglycosides, polybetaine polysiloxanes, and mixtures thereof. The alkyl polyglycosides and polybetaine polysiloxanes that can be used as humectants include those described previously as sheeting agents.

When the humectant is incorporated into the composition, it can be used in an amount based upon the amount of sheeting agent used. In general, the weight ratio of humectant to sheeting agent can be greater than 1:3, and can be provided at about 5:1 to about 1:3. It should be appreciated that the characterization of the weight ratio of humectant to sheeting agent indicates that the lowest amount of humectant to sheeting agent is 1:3, and that more humectant relative to the same amount of sheeting agent can be used. The weight ratio of humectant to sheeting agent can be about 4:1 to about 1:2, and can be about 3:1 to about 1:1.

When using a humectant in the composition, it is preferable that the sheeting agent and the humectant are not the same chemical molecule. Although alkyl polyglycosides and polybetaine polysiloxanes are identified as both sheeting agents and humectants, it should be understood that the composition preferably does not have a particular alkyl polyglycoside functioning as both the sheeting agent and the humectant, and preferably does not have a specific polybetaine polysiloxane functioning as the sheeting agent and the humectant. It should be understood, however, that different alkyl polyglycosides and/or different polybetaine polysiloxanes can be used as sheeting agents and humectants in a particular composition.

It is understood that certain components that are characterized as humectants have been used in prior compositions as, for example, processing aids, hydrotropes, solvents, and auxiliary components. In those circumstances, it is believed that the component has not been used in an amount or an in environment that provides for reducing water solids filming in the presence of high solids containing water. The use of humectants in a rinse agent composition is described in U.S. Pat. No. 6,673,760, the entire disclosure of which is incorporated herein by reference.

The concentrate can include an amount of sheeting agent and/or humectant that cooperates with the dispersant polymer to resist precipitation of the anionic surfactant by hard water. The concentrate can contain about 0.001 wt. % to about 10 wt. % of the sheeting agent and/or humectant, about 0.05 wt. % to about 1 wt-% of the sheeting agent and/or humectant, or about 0.06 wt. % to about 0.5 wt. % of the sheeting agent and/or humectant.

The amounts of dispersant polymer and at least one of sheeting agent and humectant provided in the composition can be controlled to handle the water hardness levels expected from various localities as a result of the dilution of the concentrate to a use solution. This amount can also handle hard water having a temperature less than 60° F., or less than 40° F., without visual precipitation. In general, it is expected that the weight ratio of the dispersant polymer to the total sheeting agent and/or humectant can be about 1:75 to about 75:1, about 1:30 to about 30:1, about 1:25 to about 25:1, about 1:15 to about 15:1, about 1:10 to about 10:1, and about 1:5 to about 5:1.

### The Water Component

The concentrate can be provided in the form of a solid, a paste, an aqueous or nonaqueous liquid, or a combination of solid and liquid. The concentrate can be formulated without any water or can be provided with a relatively small amount of water in order to reduce the expense of transporting the concentrate. When the concentrate is provided as a liquid, it may be desirable to provide it in a flowable form so that it can be pumped or aspirated. It has been found that it is generally difficult to accurately pump a small amount of a liquid. It is generally more effective to pump a larger amount of a liquid. Accordingly, although it is desirable to provide the concentrate with as little as possible in order to reduce transportation costs, it is also desirable to provide a concentrate that can be dispensed accurately. As a result, a concentrate according to the invention, when it includes water, it can include water in an amount to about 99 wt. %, about 30 wt. % to about 90 wt. %, or about 50 wt. % to about 70 wt. %.

It should be understood that the water provided as part of the concentrate can be relatively free of hardness. It is expected that the water can be deionized to remove a portion of the dissolved solids. The concentrate is then diluted with water available at the locale or site of dilution and that water may contain varying levels of hardness depending upon the locale. Although deionized is preferred for formulating the concentrate, the concentrate can be formulated with water that has not been deionized. That is, the concentrate can be formulated with water that includes dissolved solids, and can be formulated with water that can be characterized as hard water.

Service water available from various municipalities has varying levels of hardness. It is generally understood that the calcium, magnesium, iron, manganese, or other polyvalent metal cations that may be present can cause precipitation of the anionic surfactant. In general, because of the expected large level of dilution of the concentrate to provide a use solution, it is expected that service water from certain municipalities will have a greater impact on the potential for anionic surfactant precipitation than the water from other municipalities. As a result, it is desirable to provide a concentrate that can handle the hardness levels found in the service water of various municipalities.

When the hardness level is considered to be fairly high, it is difficult to handle the hardness using traditional builders because of the large amount of dilution water used to dilute the concentrate to form the use solution. Because builders have a tendency to act in a molar relationship with multivalent salts, it is expected that the concentrate would require a large amount of a builder component if the builder component was the only component responsible for handling the hardness. Accordingly, even if it is possible to incorporate an amount of builder into the concentrate to prevent precipitation of the anionic surfactant component, it would be desirable to provide a concentrate that did not require so much builder to handle the hardness levels found in the service water of various municipalities.

The dilution water that can be used to dilute the concentrate can be characterized as hard water when it includes at least 1 grain hardness. It is expected that the dilution water can include at least 5 grains hardness, at least 10 grains hardness, or at least 20 grains hardness.

It is expected that the concentrate will be diluted with the dilution water in order to provide a use solution having a desired level of detersive properties. If the concentrate contains a large amount of water, it is expected that the concentrate can be diluted with the dilution water at a weight ratio of at least 1:1 to provide a desired use solution. If the concentrate includes no water or very little water, it is expected that the concentrate can be diluted at a weight ratio of concentrate to dilution water of up to about 1:1000 in order to provide a desired use solution. It is expected that the weight ratio of concentrate to dilution water will be between about 1:1 and about 1:100, between about 1:2 and about 1:50, between about 1:10 and about 1:40, and between about 1:15 and about 1:30. In certain preferred applications, the concentrate can be diluted at a weight ratio of concentrate to dilution water at about 1 oz concentrate to 1 gallon of water, which is about 1:128, to provide a car wash detergent.

### Other Components

The detergent composition can include an organic solvent to modify cleaning properties and/or modify the evaporation rate of water from the surface that is cleaned. In general, the properties of modifying cleaning and modifying evaporation can be balanced depending upon the application of the use solution. In addition, the composition can include a single organic solvent or a mixture of organic solvents.

Exemplary organic solvents that can be used include hydrocarbon or halogenated hydrocarbon moieties of the alkyl or cycloalkyl type, and have a boiling point well above room temperature, i.e., above about 20° C.

Considerations for selecting organic solvents include cleaning properties and aesthetic considerations. For example, kerosene hydrocarbons function quite well for grease cutting in the present compositions, but can be malodorous. Kerosene must be exceptionally clean before it can be used, even in commercial situations. For home use, where malodors would not be tolerated, the formulator would be more likely to select solvents which have a relatively pleasant odor, or odors which can be reasonably modified by perfuming.

The C₆-C₉ alkyl aromatic solvents, especially the C₆-C₉ alkyl benzenes, preferably octyl benzene, exhibit excellent grease removal properties and have a low, pleasant odor. Likewise the olefin solvents having a boiling point of at least about 100° C., especially alpha-olefins, preferably 1-decene or 1-dodecene, are excellent grease removal solvents.

Generically, the glycol ethers useful herein have the formula R¹O—(R²O—)ₘ1H wherein each R¹ is an alkyl group which contains from about 1 to about 8 carbon atoms, each R² is either ethylene or propylene, and m¹ is a number from 1 to about 3. Exemplary glycol ethers include monopropyleneglycolmonopropyl ether, dipropyleneglycolmonobutyl ether, monopropyleneglycolmonobutyl ether, ethyleneglycolmonohexyl ether, ethyleneglycolmonobutyl ether, diethyleneglycolmonohexyl ether, monoethyleneglycolmonohexyl ether, monoethyleneglycolmonobutyl ether, and mixtures thereof.

Solvents such as pine oil, orange terpene, benzyl alcohol, n-hexanol, phthalic acid esters of C₁₋₄ alcohols, butoxy propanol, Butyl Carbitol® and 1(2-n-butoxy-1-methylethoxy)propane-2-ol (also called butoxy propoxy propanol or dipropylene glycol monobutyl ether), hexyl diglycol (Hexyl Carbitol®), butyl triglycol, diols such as 2,2,4-trimethyl-1,3-pentanediol, and mixtures thereof, can be used.

The concentrate can include the organic solvent component in an amount to provide the desired cleaning and evaporative properties. In general, the amount of solvent should be limited so that the use solution is in compliance with volatile organic compound (VOC) regulations for a particular class of cleaner. In addition, it should be understood that the organic solvent is an optional component and need not be incorporated into the concentrate or the use solution according to the invention. When the organic solvent is included in the concentrate, it can be provided in an amount of about 0.1 wt. % to about 99 wt. %, about 5 wt. % to about 50 wt. %, or about 10 wt. % to about 30 wt. %.

It can be desirable to provide the use solution with a relatively neutral or alkaline pH. In many situations, it is believed that the presence of hard water as dilution water will cause the use solution to exhibit a neutral or alkaline pH. In order to ensure a relatively neutral or alkaline pH, a buffer can be incorporated into the concentrate. In general, the amount of buffer should be sufficient to provide the use solution with a pH in the range of about 6 to 14, and preferably about 7 to 10.

The buffer can include an alkalinity source. Exemplary alkaline buffering agents include alkanolamines. An exemplary alkanolamine is beta-aminoalkanol and 2-amino-2-methyl-1-propanol (AMP).

Preferred alkanolamines are beta-aminoalkanol compounds. They serve primarily as solvents when the pH is about 8.5, and especially above about 9.0. They also can provide alkaline buffering capacity during use. Exemplary beta-aminoalkanols are 2-amino-1-butanol; 2-amino-2-methyl-1-propanol; and mixtures thereof. The most preferred beta-aminoalkanol is 2-amino-2-methyl-1-propanol since it has the lowest molecular weight of any beta-aminoalkanol which has the amine group attached to a tertiary carbon atom. The beta-aminoalkanols preferably have boiling points below about 175° C. Preferably, the boiling point is within about 5° C. of 165° C.

Beta-aminoalkanols, and especially monoethanolamine and the preferred 2-amino-2-methyl-1-propanol, are surprisingly volatile from cleaned surfaces considering their relatively high molecular weights. It is found that levels below an equivalent of about 0.010% 2-amino-2-methyl-1-propanol are insufficient to provide the necessary buffering capacity necessary to maintain the pH of the formulations within a narrow range.

Other suitable alkalinity agents that can also be used, but less desirably, include alkali metal hydroxides, i.e., sodium, potassium, etc., and carbonates or sodium bicarbonates. Water-soluble alkali metal carbonate and/or bicarbonate salts, such as sodium bicarbonate, potassium bicarbonate, potassium carbonate, cesium carbonate, sodium carbonate, and mixtures thereof, can be added to the composition of the present invention in order to improve the filming/streaking when the product is wiped dry on the surface, as is typically done in car washing applications. Filming/streaking can be particularly difficult to avoid on some clear coat paints. Preferred salts are sodium carbonate, potassium carbonate, sodium bicarbonate, potassium bicarbonate, their respective hydrates, and mixtures thereof.

Contrary to the teachings of U.S. Pat. No. 6,420,326, the concentrate can include a buffering capacity greater than the equivalent of 0.050 wt. % 2-amino-2-methyl-1-propanol without experiencing deleterious streaking on a clearcoat paint surface. In addition, the concentrate can include a buffering capacity greater than the equivalent of 0.070 wt. % of 2-amino-2-methyl-1-propanol, and greater than the equivalent of 0.1 wt. % of 2-amino-2-methyl-1-propanol.

The composition according to the invention can include complexing or chelating agents that aid in reducing the harmful effects of hardness components in service water. Typically, calcium, magnesium, iron, manganese, or other polyvalent metal cations, present in service water, can interfere with the action of cleaning compositions. A chelating agent can be provided for complexing with the metal cation and preventing the complexed metal cation from interfering with the action of an active component of the rinse agent. Both organic and inorganic chelating agents are common. Inorganic chelating agents include such compounds as sodium pyrophosphate, and sodium tripolyphosphate. Organic chelating agents include both polymeric and small molecule chelating agents. Polymeric chelating agents commonly comprise ionomer compositions such as polyacrylic acids compounds. Small molecule organic chelating agents include amino-carboxylates such as salts of ethylenediaminetetracetic acid (EDTA) and hydroxyethylenediaminetetracetic acid, nitrilotriacetic acid, ethylenediaminetetrapropionates, triethylenetetraminehexacetates, and the respective alkali metal ammonium and substituted ammonium salts thereof. Phosphonates are also suitable for use as chelating agents in the composition of the invention and include ethylenediamine tetra(methylenephosphonate), nitrilotrismethylenephosphonate, diethylenetriaminepenta(methylene phosphonate), hydroxyethylidene diphosphonate, and 2-phosphonobutane-1,2,4-tricarboxylic acid. Preferred chelating agents include the phosphonates amino-carboxylates. These phosphonates commonly contain alkyl or alkylene groups with less than 8 carbon atoms.

It should be understood that the concentrate can be provided without a component conventionally characterized as a builder, a chelating agent, or a sequestrant. Nevertheless, it is believed that these components can advantageously be incorporated into the composition. It is expected that their presence would not be provided in an amount sufficient to handle the hardness in the water resulting from the dilution water mixing with the concentrate to form the use solution when the dilution water is considered to be fairly hard water and the ratio of dilution water to the concentrate is fairly high.

Optional ingredients which can be included in the composition of the invention in conventional levels for use include hydrotropes, processing aids, corrosion inhibitors, dyes, fillers, optical brighteners, UV protectants, waxes, lubricants, surface wetting modifiers, germicides, pH adjusting agents (monoethanolamine, sodium carbonate, sodium hydroxide, hydrochloric acid, phosphoric acid, et cetera), bleaches, bleach activators, fragrances, viscosity modifiers, and the like.

The ready-to-use composition and/or the use solution can be applied as a solution by spraying on, wiping on, rubbing on, or otherwise mechanically contacting the surface with the composition. The ready-to-use composition can also be foamed during application onto a surface. If foamed on, it is desirable to do so in the absence of thickeners. However, thickeners can be used at such a level in the concentrated composition as to provide an aesthetically pleasing viscosity and yet not impacting the preferred low viscosity of the diluted composition to be applied onto a surface. In fact, it is believed that certain thickeners may have an adverse affect on cleaning when used to clean a clear coat surface if the thickener has a tendency to cause smearing, streaking, or leave a film on the surface. Specific types of thickeners that can be excluded include those thickeners that provide a thickening effect in the ready to use solution by increasing the viscosity by at least 50 cP.

Exemplary general concentrate compositions for use as a car wash detergent according to the invention can be formulated according to Table 1.

TABLE 1

| | 1st Range | 2nd Range | 3rd Range |
|---|---|---|---|
| Component | (wt. %) | (wt. %) | (wt. %) |
| water | 0-99 | 30-90 | 50-70 |
| anionic surfactant | 0.1-50 | 1-30 | 5-20 |
| nonionic surfactant | 0-50 | 1-20 | 5-10 |
| amphoteric surfactant | 0-50 | 1-20 | 2-10 |
| dispersant polymer or | 0.01-10 | 0.2-5 | 0.5-1.5 |
| dispersing polymer | | | |
| sheeting agent and/or | 0.001-10 | 0.05-1 | 0.06-0.5 |
| humectant | | | |
| lubricant | 0.1-20 | 1-10 | 2-5 |

The car wash detergent concentrate can be diluted with dilution water at a ratio of concentrate to dilution water of about 1:15 to provide a consumer car wash detergent product.

The composition can be prepared at a first location and shipped or transported to a second location for dilution. The second location can be provided with a water source that includes hardness. An exemplary type of second location is a commercial car wash facility, including car dealerships and repair shops. Another exemplary type of second location is a residential or similar location, where car owners generally wash their own vehicles.

The detergent composition, when provided as a use solution, can be applied to a surface or substrate for cleaning in a variety of forms. Exemplary forms include as a spray, as a foam, or as a large volume, such as produced by a sponge wet with the use solution.

It is believed that that composition can additionally be used for other surfaces of a vehicle, such as cleaning glass or mirrors, for prewash or presoak applications, and for brightening of wheels and other metal accents. The composition is also believed to be of benefit in cleaning hard surfaces other than vehicles, including showers, floors, concrete, walls, and other architectural surfaces. It should be understood that although the composition will typically be rinsed from the surface with rinse water, it could can be applied directly to a surface and wiped away to provide a streak free surface.

### EXAMPLE 1

### Precipitation from a Glass Cleaner Diluted with Hard Water

Several car wash detergent concentrates were prepared with the ingredients shown below in Table 2. The detergents were then diluted 1 oz/gallon with 20 grain hardness tap water and cooled in a freezer. The temperature where precipitation occurred was noted. The results are reported in Table 2.

TABLE 2

| | Composition of Conc. by Wt. % | | | |
|---|---|---|---|---|
| Ingredient | A | B | C | D |
| sodium olefin sulfonate | 29.25 | 29.25 | 29.25 | 29.25 |
| (40%) | | | | |
| laureth/myristeth-5 EO | 8.0 | 8.0 | 8.0 | 8.0 |
| cocoamidopropyl betaine | 4.5 | 4.5 | 4.5 | 4.5 |
| (35%) | | | | |
| lauramine oxide (30%) | 1.8 | 1.8 | 1.8 | 1.8 |
| glycerin | 1.8 | 1.8 | 1.8 | 1.8 |
| EO-PO copolymer | 0 | 0 | 0.05 | 0.05 |
| maleic/olefin copolymer | 0 | 0.10 | 0 | 0.10 |
| (50%) | | | | |
| water | 54.65 | 54.55 | 54.6 | 54.5 |
| Precipitation | room temp. | 54° F. | 47° F. | none noted |
| temperature? | | | | |

The “laureth/myristeth-5 EO” used was commercially available from Huntsman Chemical under the trade designation “Surfonic 25-5”.
The EO-PO copolymer used was commercially available from BASF under the trade designation “Pluronic N3”.
The maleic/olefin copolymer used was commercially available from Rohm & Haas under the trade designation “Acusol 460N”.

### EXAMPLE 2

### Hard Water Spotting on Cars

The diluted solutions from Compositions A and D in Example 1 were used to wash 6 inch by 6 inch test panels cut from the hood of a 1996 Ford Windstar. The washed panels were then rinsed with 20 grain hardness tap water and set vertically to dry in ambient conditions.

The panel washed with Composition D shown no noticeable water spotting, while the panel washed with Composition A had 4 water spots.

### EXAMPLE 3

### Car Wash Detergent Comparison

Composition D, from Example 1 was compared to four commercially available car wash detergents, “Meguiar's Gold Coast” car wash, “Meguiar's Nxt Generation” car wash, “Armor All” car wash concentrate, and “Turtlewax Ultra High Gloss” car wash.

The five detergents were diluted to 1 oz/gallon of water, having 17 grain hardness. The resulting use-solutions were compared for their removal of oily soil, their ability to suspend clay, and to tolerate hard water by not producing a precipitate. The results are reported in Table 3 and show that the experimental formulation is as good as, if not better, than commercial products.

TABLE 3

| | oily soil | clay | hard water |
|---|---|---|---|
| Product | removal | suspension | tolerance |
| Meguiar's Gold Class | good | good | poor |
| Carwash Shampoo and | | | |
| Conditioner | | | |
| Meguiar's Nxt Generation | good | good | fair |
| Carwash | | | |
| Armor All Carwash | good | good | good |
| Concentrate | | | |
| Turtlewax Platinum Series | good | good | fair |
| Ultra Gloss Carwash | | | |
| Composition D | good | good | good |

### EXAMPLE 4

### Detergent Contact Angle on Wax

A layer of a commercially available carwax, Ecolab's Professional Premium Wax, was applied to a test panel cut from a car hood.—The waxed surface was scrubbed with a sponge wetted with a ready to use detergent solution for 1000 cycles with a Gardner Abrasion Tester, available from BYK-Gardner, Silver Spring, Md. P Composition D, from Example 1 was compared to two commercially available detergents, Zipwax Extreme Car Wash” from Turtlewax and “Meguiar's Gold Class Carwash Shampoo and Conditioner” car wash, and to water.

The three detergents were diluted to 1 oz/gallon of water, having 17 grain hardness. A drop of each of resulting use-solutions, and water without detergent, were dropped onto the waxed surface. The initial contact angle of each drop was recorded, as was the contact angle after 1000 cycles of scrubbing. The “% retained” was calculated as 100× (final angle)/(initial angle). The ability of a detergent to not impact the contact angle of water on the test panel after scrubbing is believed to correlate to the retention of wax on the surface. The results are reported in Table 4, and show that the experimental formula was less likely to strip a car wax off than Zipwax Extreme Car Wash or Meguiar's Gold Class Carwash Shampoo and Conditioner.

TABLE 4

| | initial contact | final contact | |
|---|---|---|---|
| Product | angle | angle | % retained |
| Water (no detergent) | 80 | 78 | 98 |
| Composition D | 77 | 60 | 78 |
| Turtlewax's Zipwax | 88 | 65 | 74 |
| Extreme Carwash | | | |
| Meguiar's Gold Class | 92 | 62 | 67 |
| Carwash Shampoo and | | | |
| Conditioner | | | |

### EXAMPLE 5

### Formation of Precipitate

Composition D, from Example 1 was compared to three commercially available car wash detergents, “Meguiar's Gold Class Carwash Shampoo and Conditioner”, “Meguiar's Nxt Generation Car Wash”, and “Turtlewax Platinum Series Ultra High Gloss Car Wash”.

The four detergents were diluted to 1 oz/gallon of water, having 17 grain hardness, and the resulting solution was observed. As the results in Table 5 show, Composition D exhibited superior hard water resistance compared to the commercially available detergents.

TABLE 5

| Product | Comment |
|---|---|
| Meguiar's Gold Class Carwash Shampoo | significant precipitate formed |
| and Conditioner | (poor hard water tolerance) |
| Meguiar's Nxt Generation Car Wash | some precipitate formed |
| Turtlewax Platinum Series Ultra High | slight precipitate formed |
| Gloss | |
| Composition D | no-precipitate formed |

### EXAMPLE 6

### Additional Formulations

Several car wash detergent concentrates were prepared with the ingredients shown below in Table 6. The detergents were then diluted 1 oz/gallon with 20 grain hardness tap water to form the use-solution having the percentages shown below.

TABLE 6

| | Comp. E | Comp. F |
|---|---|---|
| Ingredient | Wt. % | Wt. % |
| Water | 54.165 | 59.25 |
| sodium olefin sulfonate (40%) | 29.25 | 31.8 |
| lauryl-myristyl-5 EO | 8.0 | — |
| cocoamidopropyl betaine (35%) | 4.5 | 4.9 |
| lauramine oxide (30%) | 1.8 | 1.95 |
| glycerin | 1.8 | 1.95 |
| EO-PO copolymer | 0.05 | 0.05 |
| polycarboxylate, sodium salt | 0.10 | 0.10 |
| preservative | 0.075 | — |
| citric acid | 0.04 | — |

### EXAMPLE 7

### Detergent Contact Angle

The ability of an aqueous detergent solution to wet a hydrophobic waxed surface is important to its cleaning efficiency with a lower contact angle being more desirable than a higher contact angle. The wetting ability of a ready to use dilution of composition F, from Example 6, was compared to dilutions of three commercially available detergents, “Meguiar's Nxt Generation Car Wash”, “Meguiar's Gold Class Car Wash Shampoo and Conditioner”, and “Turtlewax Platinum Series Ultra High Gloss Car Wash”, and to water. Additionally, various additives were added to Composition F, and the resulting detergents were also compared; these are noted in Table 7.

The detergents were diluted to 1 oz/gallon of water, having 17 grain hardness. A drop of each of resulting use-solutions, and water without detergent, were dropped onto a 6 inch by 6 inch test panels cut from the hood of a Chevy S-10 truck. The contact angle of the drop on the surface was measured, and the results are reported in Table 7.

TABLE 7

| Detergent | Contact Angle |
|---|---|
| Water (no detergent) | 58 |
| Composition F | 26 |
| Meguiar's Nxt Generation Car Wash | 36 |
| Meguiar's Gold Class Car Wash Shampoo | 40 |
| and Conditioner | |
| Turtlewax Platinum Series Ultra High | 30 |
| Gloss Car Wash | |
| Comp. F + 8% lauryl-myristyl-5 EO | 21 |
| Comp. F + 8% propylene glycol | 22 |
| Comp. F + 8% EO-PO copolymer | 27 |
| Comp. F + 8% propoxylated quaternary | 26 |
| ammonium compound | |
| Comp. F + 8% ethoxylated amine | 34 |
| Comp. F + 8% glycerol | 25 |
| Comp. F + 0.5% amphoteric siloxane | 25 |
| copolymer | |

The “EO-PO copolymer” was “Pluronic N3” commercially available from BASF.

The “propoxylated quaternary ammonium compound” was diethyl ammonium chloride commercially available from Goldschmidt as Variquat CC-42NS.

The ethoxylated amine was “Varonic T-205” commercially available from Goldschmidt.

The amphoteric siloxane copolymer was commercially available from Deguss as “Abil 8863.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A detergent composition comprising:
(a) 0.1-50 wt-% anionic surfactant component; and
(b) a hard water anti-precipitant mixture comprising a dispersant polymer and at least one of a sheeting agent and/or humectant, the dispersant polymer present at 0.01-10 wt-% of the composition and the at least one of a sheeting agent and/or humectant present at 0.001-10 wt-% of the composition.

2. The composition according to claim 1, wherein the amount of the hard water anti-precipitant mixture to the anionic surfactant component is sufficient to prevent visible precipitation when the composition is diluted with dilution water having 5 grain hardness.

3. The composition according to claim 1, wherein the amount of the hard water anti-precipitant mixture to the anionic surfactant component is sufficient to prevent visible precipitation when the composition is diluted with dilution water having 15 grain hardness.

4. The composition according to claim 1, wherein the anionic surfactant component comprises at least one of alkyl aryl sulfonate, secondary alkane sulfonate, alkyl methyl ester sulfonate, alpha olefin sulfonate, alkyl ether sulfate, alkyl sulfate, alcohol sulfate, and mixtures thereof.

5. The composition according to claim 1, wherein the composition contains about 1-30 wt-% of the anionic surfactant component.

6. The composition according to claim 1, wherein the dispersant polymer comprises at least one of a polymer and an oligomer, wherein the polymer and the oligomer contain pendant carboxylic acid groups, pendant carboxylic salt groups, or mixtures thereof.

7. The composition according to claim 1, wherein the dispersant polymer comprises at least one of poly(acrylic acid), poly (acrylic acid/maleic acid) copolymer, poly(maleic acid/olefin) copolymer.

8. The composition according to claim 1, wherein the composition contains about 0.2-5 wt-% of the dispersant polymer.

9. The composition according to claim 1, wherein the sheeting agent comprises at least one of nonionic block copolymer, alcohol alkoxylate, alkyl polyglycoside, zwitterionic, and mixtures thereof, and the humectant comprises at least one of glycerine, alkylene glycol, sorbitol, alkyl polyglycoside, polybetaine polysiloxane, and mixtures thereof.

10. The composition according to claim 1, wherein the composition contains about 0.05-1 wt-% of the at least one sheeting agent and/or humectant.

11. The composition according to claim 1, wherein the composition is provided as a use solution resulting from a dilution of the composition with dilution water at a weight ratio of composition to dilution water of between about 1:1 and about 1:1000.

12. The composition according to claim 11, wherein the dilution water has a hardness of at least about 5 grain.

13. The composition according to claim 1 present within water-soluble packaging.

14. The composition according to claim 1 wherein the composition is a hard surface detergent.

15. The composition according to claim 1 wherein the composition is a car wash detergent.

16. A method for providing a ready-to-use composition, the method comprising:
(a) diluting a concentrate with water to provide a ready-to-use composition, the concentrate comprising:
(i) 0.1-50 wt-% anionic surfactant component; and
(ii) a hard water anti-precipitant mixture comprising a dispersant polymer and at least one of a sheeting agent and/or humectant, the dispersant polymer present at 0.01-10 wt-% of the composition and the at least one of a sheeting agent and/or humectant present at 0.001-10 wt-% of the composition.

17. The method according to claim 16, wherein the step of diluting comprises mixing the concentrate and the water at a weight ratio of at least 1:1.

18. The method according to claim 16, wherein the amount of the hard water anti-precipitant mixture to the anionic surfactant component is sufficient to prevent visible precipitation when the car wash composition is diluted with dilution water having 5 grain hardness at a weight ratio of 1:1.

19. The method according to claim 16, wherein the amount of the hard water anti-precipitant mixture to the anionic surfactant component is sufficient to prevent visible precipitation when the composition is diluted with dilution water having 15 grain hardness at a weight ratio of 1:128.

20. The method according to claim 16, wherein the anionic surfactant component comprises at least one of alkyl aryl sulfonate, secondary alkane sulfonate, alkyl methyl ester sulfonate, alpha olefin sulfonate, alkyl ether sulfate, alkyl sulfate, alcohol sulfate, and mixtures thereof.

21. The method according to claim 16, wherein the car wash composition contains about 1-30 wt-% of the anionic surfactant component.

22. The method according to claim 16, wherein the dispersant polymer comprises at least one of a polymer and an oligomer, wherein the polymer and the oligomer contain pendant carboxylic acid groups, pendant carboxylic salt groups, or mixtures thereof.

23. The method according to claim 16, wherein the dispersant polymer comprises at least one of poly(acrylic acid), poly (acrylic acid/maleic acid) copolymer, poly(maleic acid/olefin) copolymer.

24. The method according to claim 16, wherein the composition contains about 0.2-5 wt-% of the dispersant polymer.

25. The method according to claim 16, wherein the sheeting agent comprises at least one of nonionic block copolymer, alcohol alkoxylate, alkyl polyglycoside, zwitterionic, and mixtures thereof, and the humectant comprises at least one of glycerine, alkylene glycol, sorbitol, alkyl polyglycoside, polybetaine polysiloxane, and mixtures thereof.

26. The method according to claim 16, wherein the composition contains about 0.05-1 wt-% of the at least one sheeting agent and/or humectant.

27. The method according to claim 16, wherein the method provides a ready-to-use car was composition.

28. A method for cleaning a surface, the method comprising:
(a) diluting a concentrate composition with dilution water to provide a ready-to-use composition, the concentrate composition comprising
(i) 0.1-50 wt-% anionic surfactant component; and
(ii) a hard water anti-precipitant mixture comprising a dispersant polymer and at least one of a sheeting agent and/or humectant, the dispersant polymer present at 0.01-10 wt-% of the composition and the at least one of a sheeting agent and/or humectant present at 0.001-10 wt-% of the concentrate composition;
(b) applying the ready-to-use composition to a surface for cleaning the surface.

29. The method according to claim 28, wherein the surface comprises a car surface.

30. The method according to claim 29, wherein the car surface comprises a painted surface.

31. The method according to claim 30, wherein the painted surface is a clearcoat painted surface.
